(19) United States
(12) Patent Application Publication
(10) Pub. No.: US 2024/0098105 A1
(43) Pub. Date: Mar. 21, 2024

(54) TACTICS, TECHNIQUES, AND PROCEDURES (TTP) BASED THREAT HUNTING

(71) Applicant: Trustwave Holdings Inc, Chicago, IL (US)

(72) Inventors: Shawn D. Kanady, Naperville, IL (US); Grzegorz Adam Janowski, Warsaw (PL)

(21) Appl. No.: 17/988,256

(22) Filed: Nov. 16, 2022

Related U.S. Application Data
(60) Provisional application No. 63/406,569, filed on Sep. 14, 2022.

(51) Int. Cl. H04L 9/40

(52) U.S. Cl. CPC H04L 63/1425; H04L 63/1416

(57) ABSTRACT

Aspects of the disclosure relate to TTP based threat hunting. A computing platform may store a plurality of threat actor profiles, each threat actor profile including TTP information characteristic of the corresponding threat actor. The computing platform may execute, for a first threat actor and on behalf of a plurality of individuals, a threat hunt, where: 1) executing the threat hunt comprises searching for a presence of the first threat actor based on the threat actor profile for the first threat actor, and 2) executing the threat hunt produces metadata corresponding to the first threat actor. The computing platform may send, to a SOAR computing system, commands directing the SOAR computing system to execute SOAR actions for the metadata, which may cause the SOAR computing system to execute the SOAR actions.

### CROSS REFERENCE TO RELATED APPLICATIONS

This application claims the priority benefit of U.S. Provisional Application No. 63/406,569, filed Sep. 14, 2022, and entitled “Tactics, Techniques, and Procedures (TTP) Based Threat Hunting,” which is hereby incorporated herein by reference in its entirety.

### BACKGROUND

Aspects of the disclosure relate to threat hunting. In some cases, threat hunting may be performed based on indicators of compromise (IOCs). However, once such IOCs for a particular threat actor have been published or otherwise identified, a threat actor may simply circumvent detection by modifying the corresponding information. For example, a threat actor may simply use a new compressor to compress malware, thus resulting in a different hash value that would not be identified using the previously identified IOCs. Similarly, a threat actor may simply use a different domain once a previous domain has been identified as malicious. Accordingly, it may be valuable to develop a more robust method for identifying threat actors.

Additionally, many threat hunts may be performed once a breach or other cybersecurity incident has already occurred. Although retroactively remedying a particular incident may be valuable, the incident itself may result in data leaks, time delays, costs, and/or other issues. Thus, it may be important to develop a methodology for proactively avoiding the issue altogether.

### SUMMARY

Aspects of the disclosure provide effective, efficient, scalable, and convenient technical solutions that address and overcome the technical problems associated with threat hunting and detection. In accordance with one or more embodiments of the disclosure, a computing platform, for proactive tactics, techniques, and procedures (TTP) based searching for threat actors, comprising at least one processor, a communication interface, and memory storing computer-readable instructions may store, in the memory, a plurality of threat actor profiles, each threat actor profile including TTP information characteristic of the corresponding threat actor. The computing platform may execute, for a first threat actor and on behalf of a plurality of individuals, a threat hunt, on a data repository storing one or more of: endpoint detection and response (EDR) information, server log information, network traffic information, and time-series data, where: 1) executing the threat hunt includes searching for a presence of the first threat actor based on the threat actor profile for the first threat actor, which may include a) sending, to EDR vendor systems of a plurality of EDR vendor systems, an application programming interface (API) request requesting EDR information for the first threat actor from each EDR vendor system of the plurality of EDR vendor systems, b) receiving the EDR information, and c) analyzing the EDR information to identify presence of the first threat actor, and 2) executing the threat hunt produces metadata indicating behavior of the first threat actor. The computing platform may send, to a security orchestration and automation (SOAR) computing system, one or more commands directing the SOAR computing system to execute one or more SOAR actions for the metadata indicating behavior of the first threat actor, which may cause the SOAR computing system to execute the one or more SOAR actions.

In one or more instances, the TTP information may correspond to an enterprise attack framework defining techniques and corresponding sub-techniques performed by threat actors. In one or more instances, the computing platform may receive input of the first threat actor. The computing platform may cause display, in response to receiving the input of the first threat actor, of the enterprise attack framework. The computing platform may update, on the display and in response to receiving the input of the first threat actor, the enterprise attack framework to highlight the techniques and the corresponding sub-techniques stored in the threat actor profile for the first threat actor.

In one or more examples, executing the threat hunt may include proactively executing the threat hunt for the first threat actor, prior to receiving an indication that a threat has occurred. In one or more examples, the computing platform may generate, based on the EDR information, a comma-separated values (CSV) file corresponding to each technique and sub-technique of the threat actor profile for the first threat actor, where the metadata is included in the CSV files. In one or more examples, the API request may be one or more queries, and the one or more queries may be stored in one or more configuration files. In one or more examples, the computing platform may generate, using the one or more configuration files, a master configuration file, configured to request the EDR information for the first threat actor from each of the plurality of EDR vendor systems, where sending the API request may include sending one or more queries from the master configuration file to each of the plurality of EDR vendor systems.

In one or more instances, the computing platform may input the metadata into a metadata evaluation system, which may include sending the metadata to the metadata evaluation system based on receipt of user input requesting that the metadata be sent to the metadata evaluation system. In one or more instances, the computing platform may input the metadata into a metadata evaluation system, which may include automatically routing the metadata to the metadata evaluation system along with one or more commands directing the metadata evaluation system to analyze the metadata.

In one or more examples, the metadata evaluation system may be configured to output a threat analysis result of: threat, no threat, or possible threat. In one or more examples, sending the one or more commands directing the SOAR computing system to execute one or more SOAR actions may be in response to receiving a threat analysis result of: threat or possible threat. In one or more examples, the computing platform may update, based on results of the threat hunt for the first threat actor, the threat profile for the first threat actor. In one or more examples, the one or more SOAR actions may include one or more of: blocking internet protocol (IP) addresses at a firewall, blocking hashes at the EDR vendor systems, or isolated one or more systems based on a top protocol.

In one or more instances, analyzing the EDR information to identify presence of the first threat actor may include identifying presence of a second threat actor, different than the first threat actor.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for proactive TTP based threat hunting in accordance with one or more example embodiments;

FIGS. 2A-2C depict an illustrative event sequence for proactive TTP based threat hunting in accordance with one or more example embodiments;

FIG. 3 depicts an illustrative method for proactive TTP based threat hunting in accordance with one or more example embodiments; and

FIGS. 4-6 depict illustrative graphical user interfaces for proactive TTP based threat hunting in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure describe performing proactive, tactics, techniques, and procedures (TTP) based, threat hunts across multiple technologies. More specifically, queries corresponding to each behavior and/or sub-behavior of an attack framework, such as MITRE ATT&CK™ may be generated. In these instances, the queries may be written to request information from multiple endpoint detection and response (EDR) endpoints for different vendors and/or technologies. Threat actor profiles may be generated for known threat actors, each listing the various behaviors/sub-behaviors of the attack framework that are characteristic of the given threat actor. Similarly, the corresponding queries may also be associated with these threat actor profiles. Proactive hunts may be performed (e.g., in contrast to hunts performed once an incident response is generated for a particular attack) based on TTP information across a variety of technologies. The TTP information may be analyzed to identify any malicious or suspect metadata (e.g., internet protocol (IP) address, hash, domain, indicator of compromise, command line, and/or other metadata), and security orchestration, automation, and response (SOAR) actions may be initiated for that metadata accordingly.

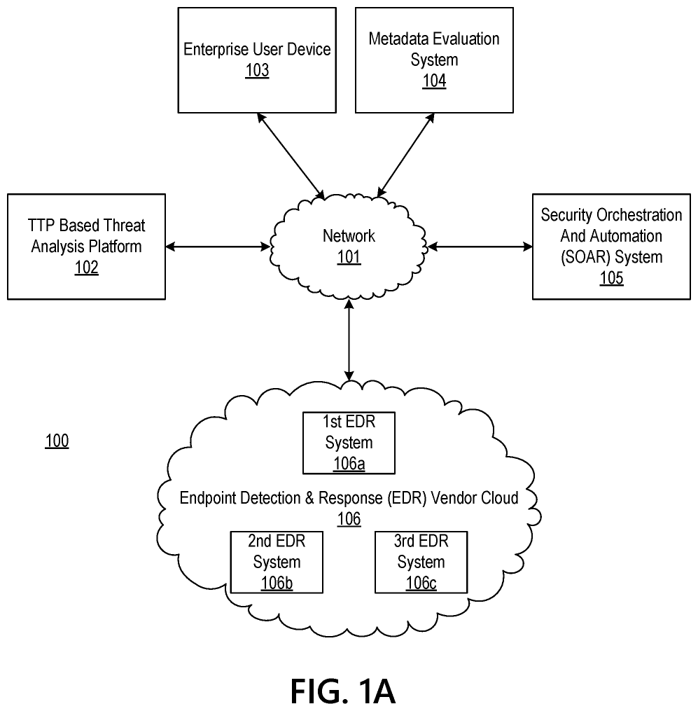

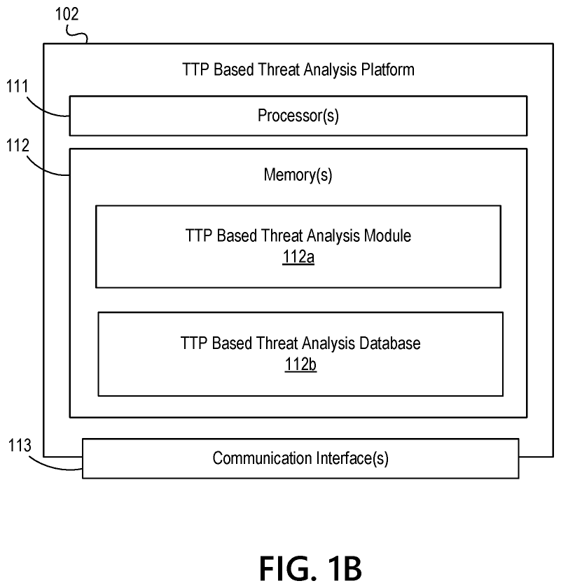

FIGS. 1A-1B depict an illustrative computing environment for proactive TTP based threat hunting in accordance with one or more example embodiments. Referring to FIG. 1A, computing environment 100 may include one or more computer systems. For example, computing environment 100 may include a TTP based threat analysis platform 102, enterprise user device 103, metadata evaluation system 104, SOAR system 105, and an EDR vendor cloud 106 (which may, e.g., include one or more EDR systems, such as first EDR system 106a, second EDR system 106b, and/or third EDR system 106c).

As described further below, TTP based threat analysis platform 102 may be a computer system that includes one or more computing devices (e.g., servers, server blades, or the like) and/or other computer components (e.g., processors, memories, communication interfaces) that may be used to host one or more threat actor profiles and support a graphical user interface for the attack framework. The TTP based threat analysis platform 102 may be configured to communicate with one or more EDR systems to obtain TTP information. In some instances, the TTP based threat analysis platform 102 may be configured to communicate with other computing platforms (e.g., metadata evaluation system 104, SOAR system 105, and/or other platforms/systems) to analyze the TTP information and/or cause performance of SOAR actions accordingly. In some instances, the TTP based threat analysis platform 102, metadata evaluation system 104, and/or SOAR system 105 may operate on a common enterprise network.

Enterprise user device 103 may be a mobile device, tablet, smartphone, desktop computer, laptop computer, and/or other device that may be used by an individual (such as a cybersecurity professional) to monitor network security, perform threat hunts, and/or perform other actions. In some instances, the enterprise user device 103 may be configured to provide one or more user interfaces (e.g., attack framework interfaces, TTP information interfaces, or the like).

Metadata evaluation system 104 may be a computer system that includes one or more computing devices (e.g., servers, server blades, or the like) and/or other computer components (e.g., processors, memories, communication interfaces) that may be used to analyze metadata/attributes (e.g., IP address, domain, hash, indicators of compromise, command line, and/or other metadata) identified by the TTP based threat analysis platform 102 and classify them (e.g., “threat,” “no threat,” “possible threat,” or the like). Although metadata evaluation system 104 is depicted as a distinct system, different than the TTP based threat analysis platform 102, in some instances, metadata evaluation system 104 may be incorporated with or otherwise integrated into the TTP based threat analysis platform 102 without departing from the scope of the disclosure.

SOAR system 105 may be a computer system that includes one or more computing devices (e.g., servers, server blades, or the like) and/or other computer components (e.g., processors, memories, communication interfaces) that may be used to execute and/or otherwise cause execution of SOAR actions (e.g., modify gateway policies, automated IP blocking, host isolation, hash blocking, initiating/modifying firewall rules, and/or other actions) for metadata/attributes classified as posing a threat or possible threat. Although SOAR system 105 is depicted as a distinct system, different than the TTP based threat analysis platform 102, in some instances, SOAR system 105 may be incorporated with or otherwise integrated into the TTP based threat analysis platform 102 without departing from the scope of the disclosure. Moreover, although SOAR system 105 is depicted as a distinct system, different than the metadata evaluation system 104, in some instances, SOAR system 105 may be incorporated with or otherwise integrated into the metadata evaluation system 104 and/or the TTP based threat analysis platform 102 without departing from the scope of the disclosure.

First, second, and third EDR systems 106a-c may store or otherwise host EDR data (e.g., TTP information) obtained from one or more devices. In some instances, the first, second, and/or third EDR systems 106a-c may correspond to different vendors and/or technologies. In some instances, the first, second, and/or third EDR systems 106a-c may be connected via the EDR vendor cloud 106. In some instances, existing EDR systems 106b may be swapped out and replaced with one or more EDR systems 106c as new vendors and/or technologies are introduced in the industry.

Computing environment 100 also may include one or more networks, which may interconnect TTP based threat analysis platform 102, enterprise user device 103, metadata evaluation system 104, SOAR system 105, or the like. For example, computing environment 100 may include a network 101 (which may interconnect, e.g., TTP based threat analysis platform 102, enterprise user device 103, metadata evaluation system 104, SOAR system 105, or the like). In some instances, the computing environment 100 may also include the EDR vendor cloud 106, which may, e.g., interconnect the first, second, and/or third EDR systems 106a-c. In some instances, systems hosted by the networks 101 may be configured to communicate with the EDR vendor cloud 106 and the systems thereon.

In one or more arrangements, TTP based threat analysis platform 102, enterprise user device 103, metadata evaluation system 104, SOAR system 105, and/or first, second, and third EDR systems 106a-c may be any type of computing device capable of sending and/or receiving requests and processing the requests accordingly. For example, TTP based threat analysis platform 102, enterprise user device 103, metadata evaluation system 104, SOAR system 105, first, second, and third EDR systems 106a-c, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of TTP based threat analysis platform 102, enterprise user device 103, metadata evaluation system 104, SOAR system 105, and/or first, second, and third EDR systems 106a-c may, in some instances, be special-purpose computing devices configured to perform specific functions.

Referring to FIG. 1B, TTP based threat analysis platform 102 may include one or more processors 111, memory 112, and communication interface 113. A data bus may interconnect processor 111, memory 112, and communication interface 113. Communication interface 113 may be a network interface configured to support communication between TTP based threat analysis platform 102 and one or more networks (e.g., network 101, EDR vendor cloud 106, or the like). Memory 112 may include one or more program modules having instructions that when executed by processor 111 cause the systems of the EDR vendor cloud 106 to perform one or more functions described herein and/or one or more databases that may store and/or otherwise maintain information which may be used by such program modules and/or processor 111. In some instances, the one or more program modules and/or databases may be stored by and/or maintained in different memory units of TTP based threat analysis platform 102 and/or by different computing devices that may form and/or otherwise make up TTP based threat analysis platform 102. For example, memory 112 may have, host, store, and/or include TTP based threat analysis module 112a and TTP based threat analysis database 112b.

TTP based threat analysis module 112a may have instructions that direct and/or cause TTP based threat analysis platform 102 to execute advanced techniques to proactively identify presence of threat actors and prevent cybersecurity threats. TTP based threat analysis database 112b may store information (e.g., attack framework information, threat actor profiles, and/or other information) used by TTP based threat analysis module 112a and/or TTP based threat analysis platform 102 in application of advanced techniques to identify presence of threat actors, prevent cyber threats, and/or in performing other functions.

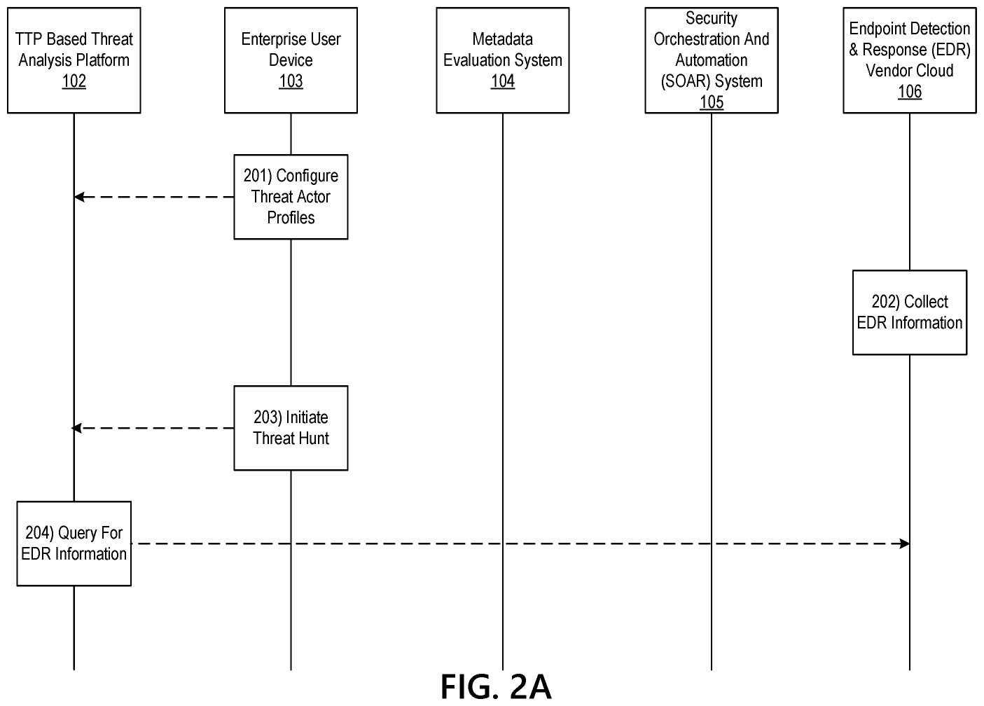

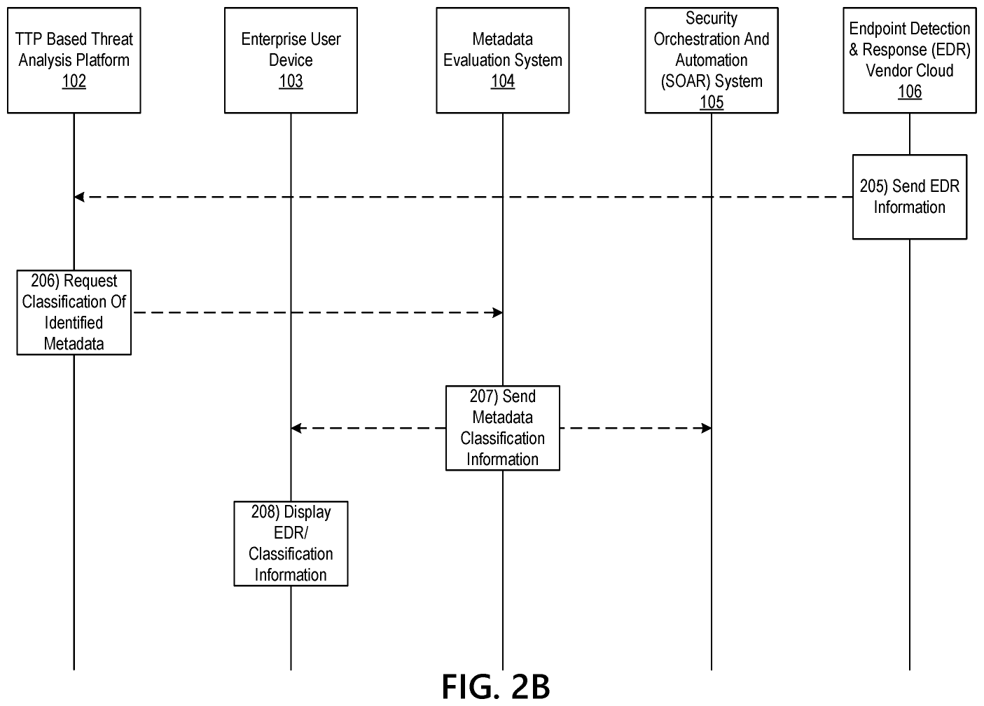

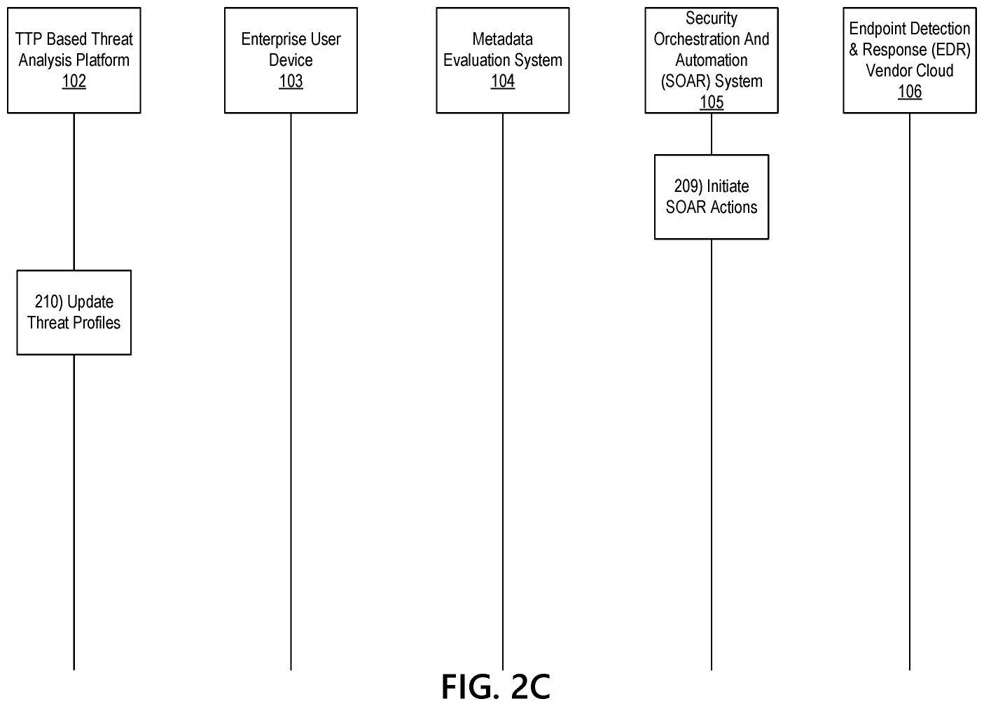

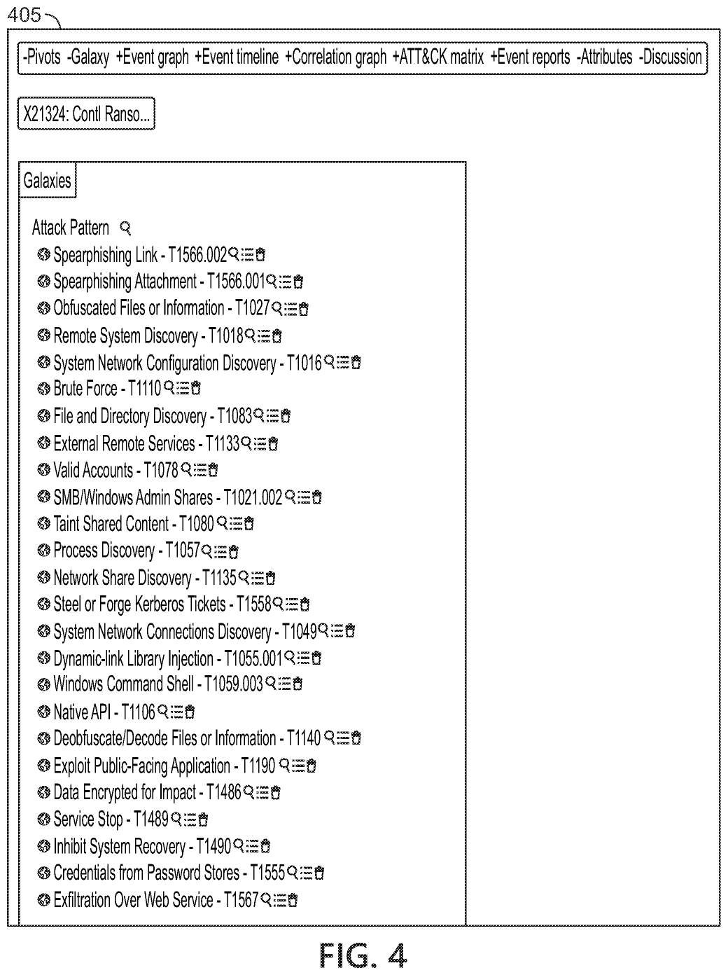

FIGS. 2A-2C depict an illustrative event sequence for proactive TTP based threat hunting in accordance with one or more example embodiments. Referring to FIG. 2A, at step 201, the enterprise user device 103 may communicate with the TTP based threat analysis platform 102 to configure threat actor profiles. For example, the enterprise user device 103 may receive user input selecting one or more behaviors and/or sub-behaviors, corresponding to an attack framework such as MITRE ATT&CK™ for each of a plurality of known threat actors. For example, the enterprise user device 103 may display a graphical user interface similar to graphical user interface 405, which is illustrated in FIG. 4, and which includes a list of behaviors and/or sub-behaviors for a given threat actor as selected by a user. It should be understood, however, that the TTP information included in the attack framework may be constantly evolving, and thus the attack framework may evolve concurrently to include such updated information.

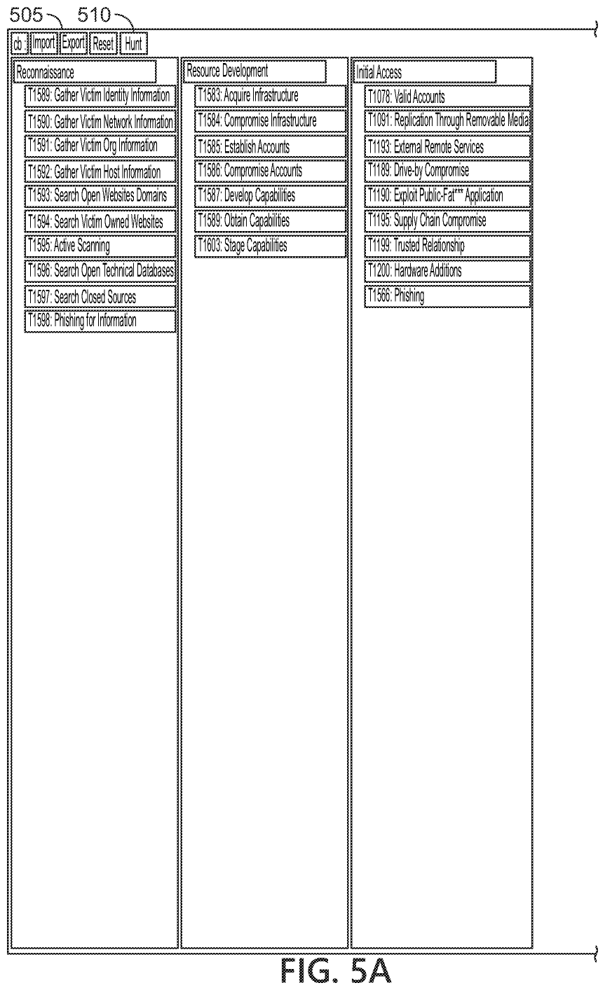

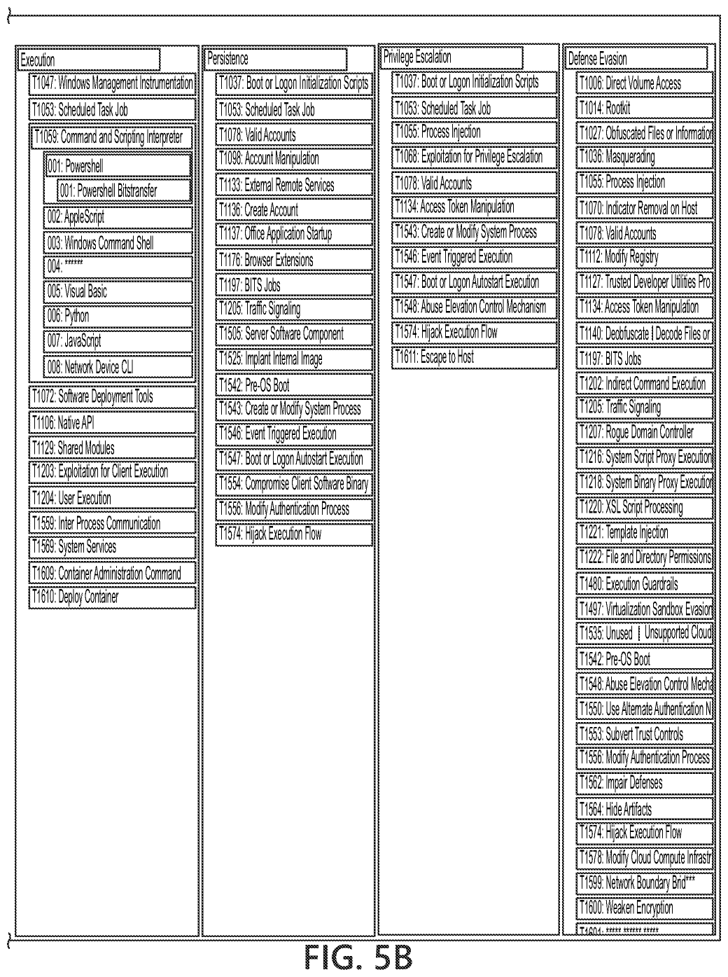

In some instances, the enterprise user device 103 may display a graphical user interface similar to graphical user interface 505, which is shown in FIG. 5, and which allows a user to select a number of techniques/subtechniques (which may, e.g., be referred to as TTP information). For example, the enterprise user device 103 may receive, for a first threat actor, a selection of “replication through removable media” as an initial access technique, and “Powershell bitstransfer,” “AppleScript,” “Windows Command Shell,” “UnixShell,” “Visual Basic,” “Python,” “JavaScript,” and “Network Device CLI,” as “command and scripting interpreter” subtechniques for execution techniques. In response to receiving such inputs, the enterprise user device 103 may communicate with the TTP based threat analysis platform 102 to create or otherwise modify a threat actor profile for the first threat actor, similar to the threat actor profile illustrated on graphical user interface 405.

In these instances, the TTP based threat analysis platform 102 may store these threat actor profiles for use. In storing the threat actor profiles, the TTP based threat analysis platform 102 may similarly store queries configured to request EDR information for each TTP technique/subtechnique along with the corresponding profile. For example, referring to the threat profile for the first threat actor described above, the TTP based threat analysis platform 102 may store queries to request EDR information corresponding to each of the listed techniques/sub-techniques. In some instances, these stored queries may be configured to request the EDR information from multiple different EDR servers/technologies. For example, the TTP based threat analysis platform 102 may be configured with multiple drivers to request such information.

In some instances, in addition or as an alternative to configuring and/or updating the threat actor profiles based on manual input from a user of the enterprise user device 103, the TTP based threat analysis platform 102 may automatically identify TTP information characteristic of various threat actors (e.g., by analyzing historical incident response logs, previously identified threat actors, and/or other information using machine learning or other techniques). In these instances, the TTP based threat analysis platform 102 may update the threat actor profiles based, at least in part, on this information.

At step 202, the first, second, and third EDR systems 106a-c may collect and store EDR information from a number of different endpoints. In some instances, the different EDR systems 106a-c may continuously collect this EDR information, which may, e.g., be illustrative/indicative of the various TTP listed in the attack framework. For example, the first, second, and third EDR systems 106a-c may collect result information corresponding to “accounts named defaultuser( ),” “accounts named administrator,” “accounts named root,” “accounts named guest,” “local admin accounts,” “all login accounts,” and/or other information. Although step 202 is listed sequentially after step 201, step 202 may be performed at any time throughout the illustrative event sequence (e.g., earlier, later, continuously, or the like) without departing from the scope of the disclosure.

At step 203, TTP based threat analysis platform 102 may initiate a threat hunt for a given threat actor (e.g., first threat actor). For example, the enterprise user device 103 may receive a user input selecting the first threat actor and selecting a “hunt” button 510, as displayed, for example, on the graphical user interface 505.

In some instances, the hunt button 510 may be a dynamically evolving user interface element. For example, a first user input may cause the hunt button 510 to produce a first query or set of queries to identify a first threat actor, a second user input may cause the hunt button 510 to produce a second query or set of queries to identify a second threat actor, etc. In some instances, these queries may be manually and/or automatically generated based on threat intelligence information (e.g., open source and/or other threat intelligence information). Additionally or alternatively, these queries and/or threat profile information may be imported from external research (e.g., a JSON or other file including behaviors for a certain threat actor). Additionally or alternatively, the queries may be generated based information from a web scrape. In these instances, configuration of the hunt button 510 may be tied to the input of a certain threat actor, so as to produce one or more queries to identify the presence of the given threat actor.

In some instances, the enterprise user device 103 may communicate with the TTP based threat analysis platform 102 to initiate the hunt. In some instances, upon receiving the user input indicating that the hunt should be initiated, the TTP based threat analysis platform 102 and/or enterprise user device 103 may cause TTP information of the attack framework on the graphical user interface 505 to be displayed and/or otherwise highlighted within the attack framework (e.g., cause techniques/sub-techniques from the first threat actors threat actor profile to be highlighted). In some instances, the enterprise user device 103 may display the attack framework for the first threat actor profile (e.g., including the above noted highlights) in response to receiving the user input selecting the first threat actor.

In some instances, in addition or as an alternative to initiating the threat hunt based on receipt of user input, the enterprise user device 103 and/or TTP based threat analysis platform 102 may initiate hunts for various threat actors automatically (e.g., on a predetermined schedule, based on updates to a corresponding threat profile, and/or otherwise).

In some instances, the TTP based threat analysis platform 102 may execute the threat hunt in a proactive manner. For example, rather than awaiting an incident response notice or message indicating that a breach or other malicious activity has occurred, and subsequently analyzing TTP information retroactively, the TTP based threat analysis platform 102 may perform a proactive TTP based threat hunt to identify the presence of a threat actor prior to the occurrence of an incident. In some instances, the TTP based threat analysis platform 102 may also use similar techniques to perform a retroactive analysis.

At step 204, once the TTP based threat analysis platform 102 initiates the threat hunt for the first threat actor at step 203, it may send an application programming interface (API) request that includes a query for EDR information corresponding to the TTP information listed in the threat actor profile for the first threat actor. In some instances, the TTP based threat analysis platform 102 may send API requests including queries requesting EDR information for each technique and/or subtechnique corresponding to the first threat actor. In some instances, the TTP based threat analysis platform 102 may send the API request(s) including the one or more queries for EDR information to the EDR vendor cloud.

In some instances, the queries may be configured to request the EDR information, corresponding to a given technique/subtechnique, from multiple different vendors/technologies (e.g., first, second, and third EDR systems 106a-c). For example, the TTP based threat analysis platform 102 may be configured with drivers corresponding to each vendor/technology, which may, e.g., be configured to generate the vendor specific queries (which may, e.g., be included in vendor specific configuration files). In some instances, the TTP based threat analysis platform 102 may be configured to generate or otherwise produce a master configuration file, including all queries for EDR information for different techniques/sub-techniques for each vendor/technology. Accordingly, the TTP based threat analysis platform 102 may transmit one or more queries (e.g., asynchronously transmitted API requests) from the master configuration file to one or more EDR systems.

In some instances, in querying the EDR systems (e.g., first, second, and third EDR systems 106a-c), the TTP based threat analysis platform 102 may use an API configured to communicate with the various EDR systems to send the queries from the configuration file(s). In some instances, in querying the EDR systems, the TTP based threat analysis platform 102 may query multiple systems asynchronously so as to more efficiently analyze EDR information for the corresponding customers (e.g., rather than processing one at time).

Referring to FIG. 2B, at step 205, the EDR vendor systems (e.g., first, second, and third EDR systems 106a-c) may send the requested EDR information. For example, in some instances, the EDR vendor systems may send EDR information corresponding to each technique/subtechnique and vendor/technology for which EDR information was requested at step 204, which may, in some instances, include metadata/attributes (e.g., IP address, hash, URL, domain, indicator of compromise, command line, and/or other metadata/attributes). Upon receiving this EDR information, the TTP based threat analysis platform 102 may generate one or more comma-separated values (CSV) files that include the EDR information. In some instances, the CSV files may include information such as timestamps, device identifiers, device names, action types, remote IP, remote port, remote URL, local IP, local port, protocol, local IP type, remote IP type, and/or other information. In some instances, the EDR vendor systems may similarly store and provide additional information such as server log information, network traffic information, and time-series data.

By hunting in this way, the TTP based threat analysis platform 102 may, in some instances, identify unknown IOCs based on the EDR information, thus illustrating a technical advantage of proactive TTP based hunting over the use of IOCs. In some instances, in addition to identifying unknown IOCs, the EDR information may identify additional threat actors besides the first threat actor. For example, in obtaining TTP/EDR information corresponding to the first threat actor, the TTP based threat analysis platform 102 and/or other computing systems may, in some instances, identify TTP patterns corresponding to other threat actor profiles, and may thus identify the presence of the corresponding threat actors accordingly.

For example, the TTP based threat analysis platform 102 or one or more other computing systems would search for in a hunt for a particular threat actor profile (e.g., the TTP information described above at step 201). As a specific example, although the TTP based threat analysis platform 102 may be in the process of performing a hunt for the first threat actor, the EDR information may correspond to TTP patterns for a second threat actor (e.g., despite the TTP based threat analysis platform 102 not intentionally looking for this second threat actor). In these instances, the TTP based threat analysis platform 102, one or more other computing systems, and/or an individual may identify the presence of the second threat actor.

As another advantage over IOC based hunting, the TTP based threat analysis platform 102 may identify the presence of a malicious actor in a more robust manner. For example, rather than relying on IOCs, which may be easily modified by threat actors once identified, the TTP based threat analysis platform 102 searches for behavioral patterns of the threat actors, which may, e.g., be robust to any changes in IOCs.

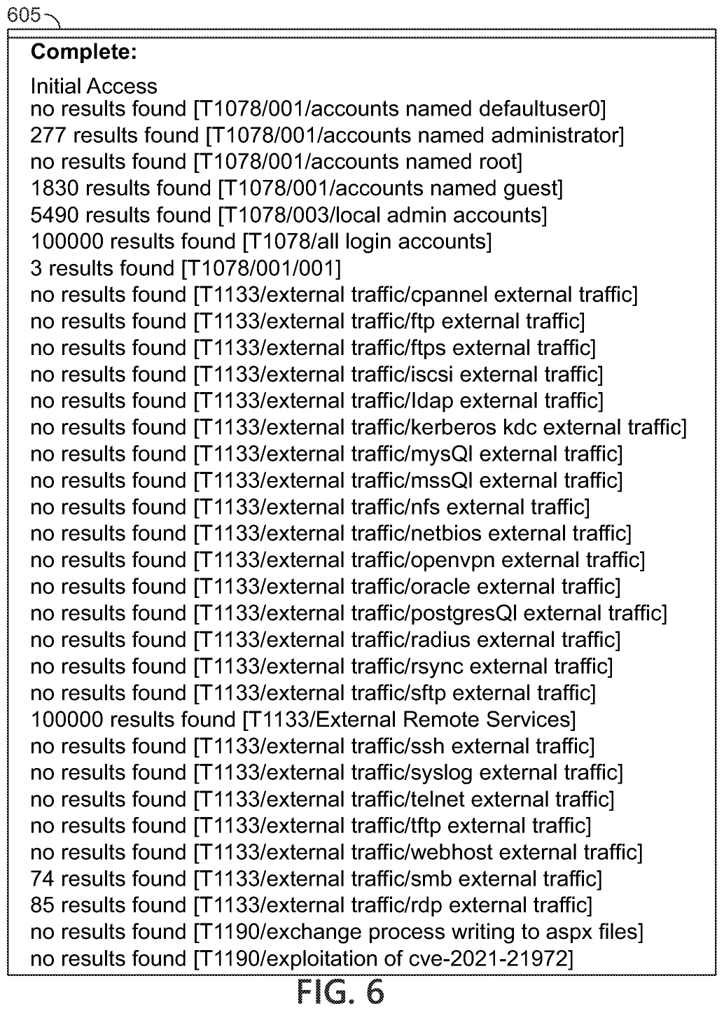

At step 206, the TTP based threat analysis platform 102 may request classification of any metadata/attributes (e.g., hash, domain, URL, and/or other metadata/attributes) included in the CSV files. For example, as illustrated in graphical user interface 605, which is shown in FIG. 6, a number of “results” may be identified for various techniques/subtechniques for “initial access.” These results may correspond to metadata/attributes that may, or might not, be malicious. Accordingly, the TTP based threat analysis platform 102 may route the metadata/attributes to the metadata evaluation system 104 for analysis. In some instances, the TTP based threat analysis platform 102 may send the CSV files, including the metadata/attributes, to the metadata evaluation system 104 based on receipt of user input indicating that the metadata/attributes should be sent. Additionally or alternatively, the TTP based threat analysis platform 102 may automatically send the CSV files upon receipt of the CSV files, at predetermined interval, or otherwise. In either instance, the TTP based threat analysis platform 102 may also send one or more commands directing the metadata evaluation system 104 to classify the metadata/attributes, which may, e.g., cause the metadata evaluation system 104 to classify the metadata/attributes as described below at step 207.

At step 207, the metadata evaluation system 104 may input the metadata/attributes from the CSV files into the metadata evaluation system 104 to output a result of “malicious,” “possibly malicious,” “not malicious,” or some similar classification (e.g., a maliciousness score, a color indicating likelihood of maliciousness (e.g., red, yellow, green, etc.), a threat classification (e.g., “threat,” “no threat,” possible threat,” etc.)), and or other classification. In some instances, the metadata evaluation system 104 may output this classification information based on comparison of the metadata/attributes to stored metadata/attributes lists (e.g., whitelists, blacklists, etc.) and or based on other data corresponding to the metadata/attributes (which may, e.g., be internally produced and/or received from third party vendors). Once the classification information is produced, the metadata evaluation system 104 may send this metadata classification information to the TTP based threat analysis platform 102, the enterprise user device 103, and/or the SOAR system 105.

At step 208, the enterprise user device 103 may display the EDR classification information and/or classification information. For example, the enterprise user device 103 may cause display of an interface listing the identified metadata/attributes and their corresponding classifications. In doing so, the enterprise user device 103 may provide information to an analyst or other enterprise employee, who may be able to further investigate metadata/attributes flagged as “malicious” or “possibly malicious,” and/or direct performance of SOAR actions accordingly.

Referring to FIG. 2C, at step 209, the SOAR system 105 may initiate one or more SOAR actions. For example, in some instances, the SOAR system 105 may initiate the one or more SOAR actions based on a request from the enterprise user device 103. Additionally or alternatively, the SOAR system 105 may automatically perform the one or more SOAR actions based on receipt of the metadata/attribute classification information from the metadata evaluation system 104. For example, the SOAR system 105 may perform the one or more SOAR actions for metadata/attribute classified as “malicious” or “possibly malicious.” For example, the SOAR system 105 may initiate one or more of modify gateway policies, perform automated IP blocking, isolate hosts, block hashes, initiate/modify firewall rules, and/or perform other actions. In some instances, the SOAR system 105 may receive one or more commands from the TTP based threat analysis platform 102, enterprise user device 103, and/or metadata evaluation system 104 directing the SOAR system to execute one or more SOAR actions for the flagged metadata/attributes (e.g., based on receiving classification information classifying metadata/attributes as “malicious” or “possibly malicious”), and may execute the one or more SOAR actions in response.

Although steps 207/209 are described as being performed by the metadata evaluation system 104 and SOAR system 105 respectively, such actions may be performed by the TTP based threat analysis platform 102 (e.g., the metadata evaluation system 104 and/or SOAR system 105 may be integrated into the TTP based threat analysis platform 102) without departing from the scope of the disclosure.

At step 210, the TTP based threat analysis platform 102 may update the threat profiles based on any EDR and/or classification information identified. For example, if, in searching for the presence of common behaviors of the first threat actor, the TTP based threat analysis platform 102 also identified that a new behavior was consistently being performed by the first threat actor (e.g., more than a threshold number of times, in a threshold percentage of attacks, or the like), the TTP based threat analysis platform 102 may update threat intelligence information corresponding to the first threat actor (e.g., at a threat intelligence platform, which may, in some instances, be different than the TTP based threat analysis platform 102). In these instances, the TTP based threat analysis platform 102 may dynamically monitor this threat intelligence information, and may update the threat actor profile for the first threat actor to include the techniques/subtechniques for this newly identified behavior based on the updated threat intelligence information accordingly. In doing so, the TTP based threat analysis platform 102 may continuously evolve, refine, and/or otherwise update the threat actor profiles through a dynamic feedback loop so as to increase the likelihood of detection, and ultimately attack prevention. For example, by updating the threat actor profile, the TTP based threat analysis platform 102 may continuously tune the queries that are sent to the various EDR systems.

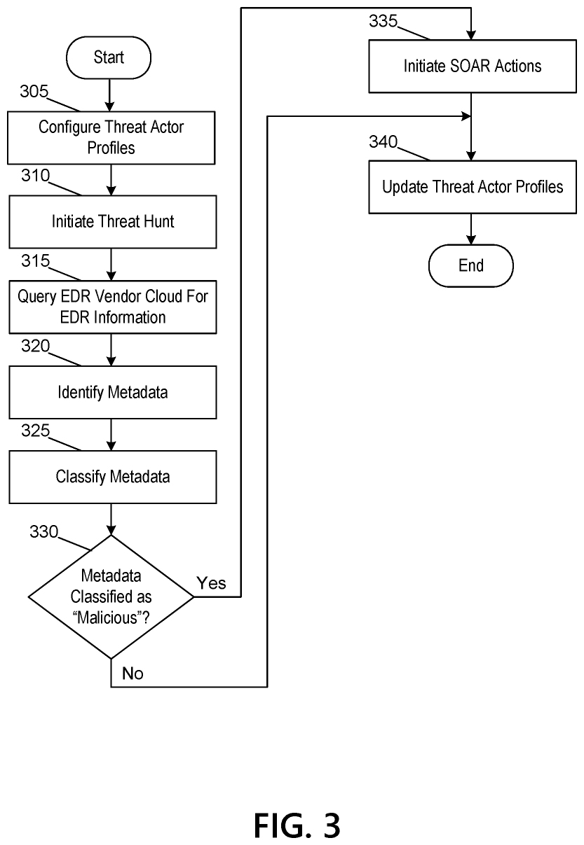

FIG. 3 depicts an illustrative method for proactive TTP based threat hunting in accordance with one or more example embodiments. Referring to FIG. 3, at step 305, a computing platform having at least one processor, a communication interface, and memory may configure threat actor profiles, using a TTP based attack framework, for known threat actors. For example, these threat actor profiles may have a data structure, such as a list of TTP information, characteristic of the corresponding threat actor. In some instances, this data structure may be further mapped to an attack framework, defining attack techniques and/or subtechniques characteristic of the corresponding threat actor (e.g., as described further above with regard to step 201). Such a data structure may have a technical advantage by enabling proactive TTP based threat hunting, which may e.g., offer advantages over retroactive evaluation and/or IOC based threat hunting (e.g., by identifying attack instances and/or presence of threat actors that may otherwise be undetected). Similarly, by enabling proactive hunting rather than merely retroactive analysis, threats/attacks may be identified and thus prevented in advance. At step 310, the computing platform may initiate a threat hunt for a first threat actor, based on the threat actor profile for the first threat actor. At step 315, the computing platform may query an EDR vendor cloud, using a master configuration file including queries configured to request EDR data for multiple different techniques and subtechniques of the TTP based attack framework from multiple EDR vendors, to obtain EDR information corresponding to the first threat actor. At step 320, the computing platform may identify metadata.

At step 325, the computing platform may classify the metadata as “malicious,” “possibly malicious,” “not malicious,” and/or otherwise. At step 330, the computing platform may identify whether any metadata was classified as “malicious.” If not, the computing platform may proceed to step 340 to update the threat actor profile for the first threat actor. For example, at step 340, the computing platform may modify the data structure of the threat actor profile (e.g., the list of TTP information and/or the attack framework corresponding to the first threat actor) so as to include any newly identified TTP information as identified from the EDR information. For example, in analyzing the EDR information, the computing platform may identify that the first threat actor is performing a new threat/attack technique, not previously associated with the first threat actor. Accordingly, the computing platform may dynamically modify the data structure of the threat actor profile for the first threat actor to include this new threat/attack technique.

Otherwise, if any metadata was classified as malicious, the computing platform may proceed to step 335. At step 335, the computing platform may initiate one or more SOAR actions for any malicious metadata. At step 340, the computing platform may update the threat actor profile for the first threat actor as described above.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform for proactive tactics, techniques, and procedures (TTP) based searching for threat actors, the computing platform comprising:
at least one processor;
a communication interface communicatively coupled to the at least one processor; and
memory storing computer-readable instructions that, when executed by the at least one processor, cause the computing platform to:
store in the memory a plurality of threat actor profiles, each threat actor profile including TTP information characteristic of the corresponding threat actor;
execute, for a first threat actor and on behalf of a plurality of individuals, a threat hunt on a data repository storing one or more of: endpoint detection and response (EDR) information, server log information, network traffic information, and time-series data, wherein:
executing the threat hunt comprises searching for a presence of the first threat actor based on the threat actor profile for the first threat actor, wherein executing the threat hunt comprises:
sending, to EDR vendor systems of a plurality of EDR vendor systems, an application programming interface (API) request requesting EDR information for the first threat actor from each EDR vendor system of the plurality of EDR vendor systems,
receiving the EDR information; and
analyzing the EDR information to identify presence of the first threat actor;
executing the threat hunt produces metadata indicating behavior of the first threat actor; and
send, to a security orchestration and automation (SOAR) computing system, one or more commands directing the SOAR computing system to execute one or more SOAR actions for the metadata indicating behavior of the first threat actor, wherein sending the one or more commands directing the SOAR computing system to execute the one or more SOAR actions causes the SOAR computing system to execute the one or more SOAR actions.

2. The computing platform of claim 1, wherein the TTP information corresponds to an enterprise attack framework defining techniques and corresponding sub-techniques performed by threat actors.

3. The computing platform of claim 2, wherein the memory stores additional computer readable instructions that, when executed by the one or more processors, cause the computing platform to:
receive input of the first threat actor;
cause display, in response to receiving the input of the first threat actor, of the enterprise attack framework; and
update, on the display and in response to receiving the input of the first threat actor, the enterprise attack framework to highlight the techniques and the corresponding sub-techniques stored in the threat actor profile for the first threat actor.

4. The computing platform of claim 1, wherein executing the threat hunt comprises proactively executing the threat hunt for the first threat actor, prior to receiving an indication that a threat has occurred.

5. The computing platform of claim 1, wherein the memory stores additional computer readable instructions that, when executed by the one or more processors, cause the computing platform to:
generate, based on the EDR information, a comma-separated values (CSV) file corresponding to each technique and sub-technique of the threat actor profile for the first threat actor, wherein the metadata is included in the CSV files.

6. The computing platform of claim 1, wherein the API request comprises one or more queries, and wherein the one or more queries are stored in one or more configuration files.

7. The computing platform of claim 1, wherein the memory stores additional computer readable instructions that, when executed by the one or more processors, cause the computing platform to:
generate, using the one or more configuration files, a master configuration file, configured to request the EDR information for the first threat actor from each of the plurality of EDR vendor systems, wherein sending the API request comprises sending one or more queries from the master configuration file to each of the plurality of EDR vendor systems.

8. The computing platform of claim 1, wherein the memory stores additional computer readable instructions that, when executed by the one or more processors, cause the computing platform to:
input the metadata into an metadata evaluation system, wherein inputting the metadata into the metadata evaluation system comprises:
sending the metadata to the metadata evaluation system based on receipt of user input requesting that the metadata be sent to the metadata evaluation system.

9. The computing platform of claim 1, wherein the memory stores additional computer readable instructions that, when executed by the one or more processors, cause the computing platform to:
input the metadata into a metadata evaluation system, wherein inputting the metadata into the metadata evaluation system comprises:
automatically routing the metadata to the metadata evaluation system along with one or more commands directing the metadata evaluation system to analyze the metadata.

10. The computing platform of claim 9, wherein the metadata evaluation system is configured to output a threat analysis result of: threat, no threat, or possible threat.

11. The computing platform of claim 9, wherein sending the one or more commands directing the SOAR computing system to execute one or more SOAR actions is in response to receiving a threat analysis result of: threat or possible threat.

12. The computing platform of claim 1, wherein the memory stores additional computer readable instructions that, when executed by the one or more processors, cause the computing platform to:
update, based on results of the threat hunt for the first threat actor, the threat profile for the first threat actor.

13. The computing platform of claim 1, wherein the one or more SOAR actions comprise one or more of: blocking internet protocol (IP) addresses at a firewall, blocking hashes at the EDR vendor systems, or isolated one or more systems based on a top protocol.

14. The computing platform of claim 1, wherein analyzing the EDR information to identify presence of the first threat actor further comprises identifying presence of a second threat actor, different than the first threat actor.

15. A method for proactive tactics, techniques, and procedures (TTP) based searching for threat actors, the method comprising:
at a computing platform comprising at least one processor, a communication interface, and memory:
storing, in the memory a plurality of threat actor profiles, each threat actor profile including TTP information characteristic of the corresponding threat actor;
executing, for a first threat actor and on behalf of a plurality of individuals, a threat hunt on a data repository storing one or more of: endpoint detection and response (EDR) information, server log information, network traffic information, and time-series data, wherein:
executing the threat hunt comprises searching for a presence of the first threat actor based on the threat actor profile for the first threat actor, wherein executing the threat hunt comprises:
sending, to EDR vendor systems of a plurality of EDR vendor systems, an application programming interface (API) request requesting EDR information for the first threat actor from each EDR vendor system of the plurality of EDR vendor systems,
receiving the EDR information; and
analyzing the EDR information to identify presence of the first threat actor; and
executing the threat hunt produces metadata indicating behavior of the first threat actor; and
sending, to a security orchestration and automation (SOAR) computing system, one or more commands directing the SOAR computing system to execute one or more SOAR actions for the metadata indicating behavior of the first threat actor, wherein sending the one or more commands directing the SOAR computing system to execute the one or more SOAR actions causes the SOAR computing system to execute the one or more SOAR actions.

16. The method of claim 15, wherein the TTP information corresponds to an enterprise attack framework defining techniques and corresponding sub-techniques performed by threat actors.

17. The method of claim 16, further comprising:
receiving input of the first threat actor;
causing display, in response to receiving the input of the first threat actor, of the enterprise attack framework; and
updating, on the display and in response to receiving the input of the first threat actor, the enterprise attack framework to highlight the techniques and the corresponding sub-techniques stored in the threat actor profile for the first threat actor.

18. The method of claim 15, wherein executing the threat hunt comprises proactively executing the threat hunt for the first threat actor, prior to receiving an indication that a threat has occurred.

19. The method of claim 15, further comprising: generating, based on the EDR information, a comma-separated values (CSV) file corresponding to each technique and sub-technique of the threat actor profile for the first threat actor, wherein the metadata is included in the CSV files.

20. One or more non-transitory computer-readable media storing instructions that, when executed by a computing platform, comprising at least one processor, a communication interface, and memory, and configured to perform a method for proactive tactics, techniques, and procedures (TTP) based searching for threat actors, cause the computing platform to:
store in the memory a plurality of threat actor profiles, each threat actor profile including TTP information characteristic of the corresponding threat actor;
execute, for a first threat actor and on behalf of a plurality of individuals, a threat hunt on a data repository storing one or more of: endpoint detection and response (EDR) information, server log information, network traffic information, and time-series data, wherein:
executing the threat hunt comprises searching for a presence of the first threat actor based on the threat actor profile for the first threat actor, wherein executing the threat hunt comprises:
sending, to EDR vendor systems of a plurality of EDR vendor systems, an application programming interface (API) request requesting EDR information for the first threat actor from each EDR vendor system of the plurality of EDR vendor systems,
receiving the EDR information; and
analyzing the EDR information to identify presence of the first threat actor;
executing the threat hunt produces metadata indicating behavior of the first threat actor; and
send, to a security orchestration and automation (SOAR) computing system, one or more commands directing the SOAR computing system to execute one or more SOAR actions for the metadata indicating behavior of the first threat actor, wherein sending the one or more commands directing the SOAR computing system to execute the one or more SOAR actions causes the SOAR computing system to execute the one or more SOAR actions.
